(19) United States
(12) Patent Application Publication
(10) Pub. No.: US 2011/0163274 A1
(43) Pub. Date: Jul. 7, 2011

(54) ELECTRODE COMPOSITE, BATTERY ELECTRODE FORMED FROM SAID COMPOSITE, AND LITHIUM BATTERY COMPRISING SUCH AN ELECTRODE

(75) Inventors: Dominique Plee, Lons (FR); Bernard Lestriez, Vigoulet Auzil (FR); Dominique Guyomard, Sautron (FR); Sabrina Desaever, Cergy (FR)

(73) Assignee: Arkema France, Colombes (FR)

(21) Appl. No.: 13/061,642

(22) PCT Filed: Aug. 20, 2009
(86) PCT No.: PCT/FR2009/051612

§ 371 Date: Mar. 28, 2011

(30) Foreign Application Priority Data
Sep. 2, 2008 (FR) 0855883

(51) Int. Cl. H01B 1/02; H01B 1/04; H01B 1/24; B05D 5/12; B82Y 30/00

(52) U.S. Cl. 252/503; 252/502; 252/511; 427/78; 977/742; 977/762

(57) ABSTRACT

An electrode composite and to its manufacturing process. The composite includes an active element, i.e. one exhibiting electrochemical activity, a conductive additive and a binder. The conductive additive is a mixture of conductive additives containing at least carbon nanofibres (CNFs) and at least carbon nanotubes (CNTs). Also, the negative electrodes for electrochemical devices of the lithium battery type including said composite and to the secondary (Li-ion) batteries provided with such a negative electrode.

### FIELD OF THE INVENTION

The invention relates to an electrode composite and also to battery electrodes formed from said composite and lithium batteries comprising such electrodes.

The invention is applicable in the field of electrical energy storage in batteries and more particularly in secondary Li-ion lithium batteries.

### TECHNOLOGICAL BACKGROUND OF THE INVENTION

The electrode composites comprise an active element, i.e. an element capable of exhibiting electrochemical activity with respect to a metal, a binder and a conductive additive.

For the negative electrode of a battery, the active element used is most conventionally graphite, while cobalt oxide is used for the positive electrode. However, silicon Si and tin Sn are also found for the negative electrode of lithium batteries.

The term “Li-ion battery” is understood to mean a battery which comprises at least a negative electrode or anode, a positive electrode or cathode, a separator and an electrolyte. The electrolyte consists of a lithium salt, generally lithium hexafluorophosphate, mixed with a solvent, which is a mixture of organic carbonates chosen to optimize the transport and dissociation of the ions. A high dielectric constant is favourable to ion dissociation, and therefore to the number of ions available in a given volume, whereas a low viscosity is favourable to ion diffusion which, among other parameters, plays an essential role in the charge and discharge rates of the electrochemical system.

As is known, an electrode for a lithium battery comprises a current collector on which is deposited a composite comprising an active element, which is active with respect to lithium, a polymer, which acts as binder and is generally a vinylidene fluoride copolymer, and an electrically conductive additive, which is generally carbon black.

When the battery is being charged, lithium is inserted into the negative electrode active element and its concentration in the solvent is kept constant by an equivalent amount being extracted from the cathode active element.

Insertion into the negative electrode results in lithium reduction and therefore it is necessary to supply, via an external circuit, electrons to this electrode going from the positive electrode.

At discharge, the reverse reactions take place.

Li-ion batteries are used in particular in mobile telephones, computers and lightweight equipment.

Other applications are envisaged, such as automotive transport by electric vehicles or hybrid vehicles. Indeed, reflections on the influence of anthropogenic CO₂ on climate warming and the need to be less dependent on the consumption of fossil fuels have led to a very strong resurgence of interest in electricity storage systems, in particular for batteries.

Renewable energy sources, such as photovoltaic and windpower systems, are intermittent and storage seems the best method for the optimum use and management of energy production.

Among electrochemical energy storage systems, Li-ion batteries have practically the highest energy density of all rechargeable systems and are therefore widely envisaged as electrical energy source in tramways, electric vehicles and hybrid vehicles in the future, in particular those (called “plug-in hybrids”) that can be recharged directly via the mains.

However, they have a few drawbacks that the worldwide scientific community is endeavouring to solve.

Currently, the technical problem to be solved is the fact that the cost per kWh stored is still high. This problem cannot in fact be correctly solved by the existing solutions, leading to many research studies in particular on alternative active elements, both as positive electrode (phosphates, various oxides, etc.) and as negative electrode (silicon, tin, various alloys, etc.).

The desired properties of such batteries are mainly the following:

high charge/discharge rate;

good capacity retention performance with cycling;

capacity retention as a function of current density;

low irreversible capacitance; and

low internal resistance, especially at low temperature.

The latest negative electrode active elements have a considerably higher capacity than graphite, which reaches 372 mAh/g, thereby making it possible in theory to have the same capacity in a smaller volume or to have a higher capacity in the same volume.

The theoretical capacity of Si is 4200 mAh/g, whereas that of Sn is 1400 mAh/g.

However, it is accepted that the large volume changes brought about by charging and discharging result in mechanical stresses and loss of cohesion of the electrode. This loss is accompanied over the course of time by a very large reduction in capacity and an increase in internal resistance.

Patent application EP 0 997 543 A1 of 29 Oct. 1999 (Ramot University, Israel) “Nanostructure alloy anodes, process for their preparation and lithium batteries comprising said anodes” claims a structure that contains metal alloys in the form of nanoparticles 20 to 500 nm in size, which are bound together and electrolytically fixed to a support. These alloys contain Sn or Zn as main constituent (40-90%) and incorporate other elements selected from the group comprising carbon and a metal, namely Sb, Zn, Ag, Cu, Fe, Bi, Co, Mn or Ni, at least 40% of which may be reversibly lithiated.

The capacity after 30 cycles, for four Sn—Sb—Cu alloys tested, varies from 100 to 450 mAh/g with a positive influence of the Sb content. However, the capacity as a function of the current density decreases, especially when the Sb content is high (no value reaches 400 mAh/g at 2 mA/cm²).

The performance of these alloys is therefore not significantly greater than that of graphite.

A method in which an alloy is used is claimed in US patent application 2008/0003503 of 3 Jan. 2008 in the name of Canon Kabushiki Kaisha, the objective of which is to prepare a silicon-tin composite covered with a protective tungsten, titanium, molybdenum, niobium or vanadium oxide film. A conductive additive, to be chosen from mesoporous carbons, carbon nanotubes or carbon fibres, is added.

However, the performance deteriorates with cycling substantially.

Patent JP-A-2002-8652 discloses a negative electrode prepared by depositing fine Si particles on a graphite powder and then producing a carbon coating. However, these electrodes suffer from loss of electrical contact problems over the course of time.

The opposite approach, consisting in covering a carbon material with silicon, is disclosed in “Electrochemical characteristics of silicon coated graphite prepared by gas suspension spray method for anode material of lithium secondary batteries”, Bup Ju Jeon et al., Korean J. Chem. Eng. 23 (5), (2006), 854-859.

In the above work, a carbon/silicon (C/Si) composite is manufactured in a fluidized bed by injecting dichlorodimethylsilane onto 10-micron graphite particles, followed by calcining at 500° C. The capacity after 10 cycles is 479 mAh/g under the best conditions and depends strongly on the solvent mixture used.

The difference over graphite is not very large, given the difficulty of the fluidized-bed process for particle sizes of this order.

These tentative differences show that the coating of the nanoscale active element with a carbon species or, conversely, the coating of a carbon material with silicon nanoparticles does not constitute, methods for achieving a substantial improvement in performance of the negative electrode.

International patent application WO 2004/049473 A2 (Showa Denko) of 10 Jun. 2004 describes an electrode material containing a compound based on Si or Sn and a fibrous carbon. The electrode material in question is a composite prepared by dispersing Si or Sn particles 20 microns in size and carbon nanofibres 150 nm in diameter in an alcoholic solution of a phenolic resin. The composite is dried and calcined in argon at 2900° C.

The best result is obtained on a composite having a 10% fibre content: specifically, this composite has a capacity of 589 mAh/g up to 50 cycles.

This result is better than in the previous examples and greater than that obtained with graphite. However, the process for obtaining the composite is quite complicated and the composite cost/performance ratio is lower than for a conventional graphite electrode. The resulting stabilization during cycling is obtained only with 10% conductive additive or more.

The principle of carbonizing a polymeric precursor is used in “Electrochemical dilatometric study on Si-embedded carbon nanotubes powder electrodes” by S. Park et al., Electrochemical and Solid State Letters, 10 (6), (2007), A 142-145. The 20-micron silicon particles are dispersed in THF with carbon nanotubes and PVC. After ultrasonification, the suspension is dried and the solid treated at 900° C. in argon. After 20 cycles, the capacity is only 650 mAh/g of electrode for composites incorporating up to 30% nanotubes. 35% nanotube content is necessary in order to achieve a capacity of 750 mAh/g of electrode at the twentieth cycle. When silicon particles 500 nm in diameter are used instead of 20-micron particles, the value then becomes 970 mAh/g of electrode at the twentieth cycle. However, it is not specified whether the reduction in silicon particle size is accompanied by a lowering of the electrode density. Furthermore, the capacity is not stable with cycling.

Thus, according to the prior art presented above, the simple and inexpensive processes, such as physical mixing, do not significantly improve the performance over the current solutions, i.e. solutions using graphite.

Conversely, the technical solutions that do seem to improve the performance significantly entail processes that are costly or complicated to implement. Some of these are multi-step processes with loss of efficiency at each step and/or employ organic solvents (THF: tetrahydrofuran).

It is apparent from the above prior art that the technical problem of retaining the highest possible capacity is an unsolved problem. Reducing the size of the tin or silicon particles does provide an improvement, but it cannot prevent the loss of properties.

The reader may also refer to the prior art formed by document D1: JP2007-335283 (US 2008/0096110) published on 24 Apr. 2008, filed by Matsushita Electric Industrial, which describes a negative electrode.

The problem addressed by this document D1 is also that of obtaining a negative battery electrode having a high capacity retention during charge and discharge cycles. To do this, it proposes the use of an active material capable of forming a reversible alloy with lithium, comprising at least one metal and at least one semiconductor. The results are improved when the electrode substrate is conductive and porous and when the active material fills the pores of the substrate.

Thus, the electrode comprises an active material comprising both a metal (such as Ti) and a semimetal (a semiconductor such as Si), a conductive material such as carbon nanotubes (CNTs) and a porous conductive substrate.

The same problem as that of the present invention has been solved in the above patent not by the choice of the conductive additive, as will be seen hereinafter in respect of the present invention, but by the choice of the active material which comprises a combination of two elements (metal and semimetal). This solution is different from that proposed in the present invention.

The reader may also refer to document D2: US 2006/172196 published on 3 Aug. 2006 and filed by Matsushita Electric Industrial.

The above document describes a process for manufacturing a negative electrode for a rechargeable battery. According to the process, a mixture of conductive material containing fibrous carbon, a polymer and a dispersing medium is produced, to which mixture a silicon-containing active material is added. The use of CNTs or CNFs as conductive material is given as an example. The teaching provided by the above document is similar to that described previously in the case of the document WO 2004/049473, but does not solve the problem posed.

Another problem that has been solved by the present invention is that of developing a simple and easily industrializable process for manufacturing the electrode material, making it possible to achieve moderate stored kW costs and thus enabling batteries using said electrodes to be widely disseminated.

For this purpose, the invention provides an electrode composite for the manufacture of negative electrodes for batteries, so that said batteries have as high a capacity retention with cycling as possible.

Furthermore, the electrode composite gives the batteries a low internal resistance and the highest possible charge and discharge rates.

The invention also provides an industrial process for manufacturing the electrode composite, the electrodes obtained, and the batteries incorporating said electrodes.

The technical problem solved is, in particular but not exclusively, the production of a composite which is active with respect to lithium and capable of reversibly forming alloys therewith. The composite is used to manufacture negative electrodes of Li-ion batteries. The negative electrodes may be incorporated into a battery having as high a capacity retention with cycling as possible, a low internal resistance and charge and discharge rates as high as possible.

### SUMMARY OF THE INVENTION

Although the prior art demonstrates an improvement in the performance of negative electrodes based on an active element capable of reversibly forming an alloy with lithium when a conventional conductive additive is completely or partly substituted with carbon nanotubes or carbon nanofibres, no document however, including D1, either describes or suggests the use of a conductive additive comprising at least carbon nanofibres and carbon nanotubes to solve the problem of achieving the highest possible capacity retention.

The expression “carbon nanotubes or CNTs” is understood to mean one or more hollow tubes having one or more graphite plane walls or graphene sheets, which are coaxial, or a graphene sheet wound up on itself. These tubes, which are usually “open” (i.e. open at one end), resemble a number of coaxially disposed lattice tubes—in cross section, the CNTs take the form of concentric rings. The external diameter of the CNTs is 2 to 50 nm. There are single-walled carbon nanotubes or SWNTs and multi-walled carbon nanotubes or MWNTs.

The expression “carbon nanofibres or nanofibrilles or CNFs” is understood to mean solid graphitic carbon fibres with a diameter of 50 to 200 nm, which may often have a fine hollow central channel. In cross section, CNFs are in the form of a disc.

For both the nanotubes and nanofibres, the length-diameter ratio is very much greater than 1, typically greater than 100.

It should be pointed out that in no example described in document D1 is it mentioned that the conductive material comprises a mixture of CNTs and CNFs as in the present invention. The CNTs are used by themselves as conductive element. Even though on page 2, column 1 [0022], the phrase “the conductive material is at least one of carbon nanotube and carbon nanofiber” is mentioned, it cannot be understood on reading the detailed description that said document discloses a conductive material comprising both CNTs and CNFs. In all the examples given, the CNTs are alone. The range of values of the diameter given in paragraph [0080] corresponds to the diameter of the CNTs.

The subject of the invention is more particularly an electrode composite comprising a conductive additive, principally characterized in that the conductive additive is a mixture of conductive additives containing at least carbon nanofibres (CNFs) and at least carbon nanotubes (CNTs).

According to another feature, the mixture may comprise other conductive additives chosen from graphite, carbon black, such as acetylene black, and sp-carbon.

The carbon nanofibres have a diameter that may range from 50 to 200 nm and have an aspect ratio that may range from 10 to 1000 and the carbon nanotubes have a diameter of between 0.4 and 20 nm and an aspect ratio of 20 to 1000.

The composite according to the invention furthermore includes what is called an active element, i.e. an element operating on the principle of insertion (Li⁺), conversion, displacement and dissolution-recrystallization, for the electrode that contains said active element.

The composite comprises an active element capable of making reversible alloys with lithium, such as for example silicon (Si) and tin (Sn).

Another subject of the invention is an electrode comprising said composite.

The electrode may be the negative electrode for electrochemical devices of the lithium battery type.

The subject of the invention is also the use of such an electrode in a non-aqueous electrolyte secondary battery, and also the secondary (Li-ion) battery having the electrode comprising said composite.

During its operation, the charge and discharge operations of the battery involve lithium insertion ranging from 0 to 1.1 lithium atoms inserted per silicon atom.

The invention also relates to the manufacture of non-aqueous electrolyte secondary batteries and to the lithium secondary batteries having an electrode comprising said composite.

According to the invention, the composite can be used in a non-aqueous electrolyte secondary battery having excellent capacity and cycling characteristics at high current density.

The invention also relates to a process for manufacturing an electrode composite, comprising:

preparation of a suspension containing a binder P1, at least carbon nanofibres CNFs imparting electron conductivity, at least carbon nanotubes CNTs imparting electron conductivity, an active electrode element M1 capable of reversibly forming an alloy with lithium, and a volatile solvent S1; and

production of a film from the suspension obtained.

The invention also relates to the use of the process for manufacturing a composite for the manufacture of electrodes for electrochemical devices of the lithium battery type.

The film on the substrate may be used directly as electrode.

The invention applies to the use of the process for manufacturing a non-aqueous electrolyte secondary battery having an electrode comprising the composite thus obtained.

Other features and advantages of the invention will become clearly apparent on reading the following description given by way of non-limiting illustrative example and in conjunction with the figures in which:

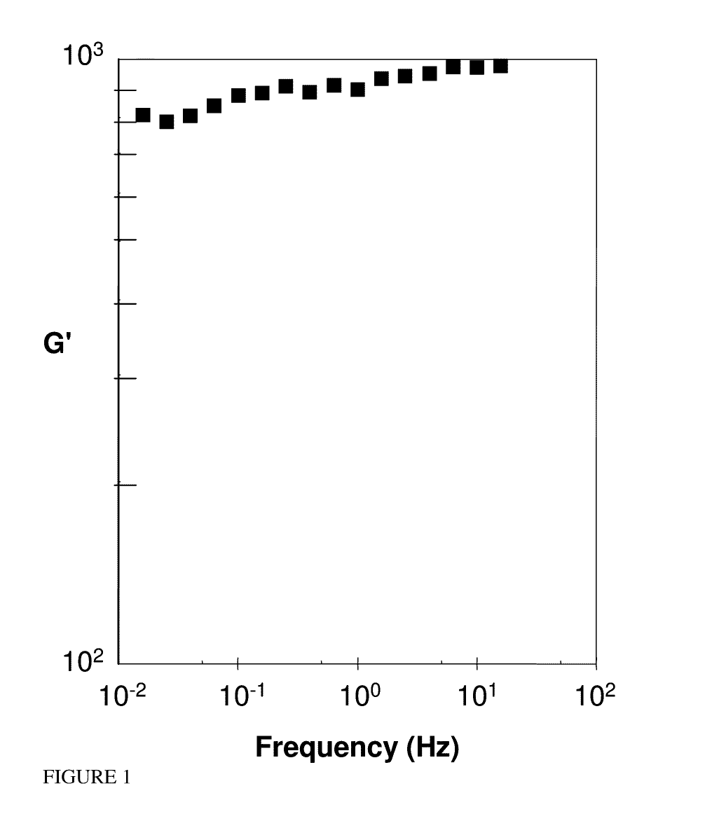

FIG. 1 shows, in graph form, the rheological characteristics of a dispersion obtained according to the process of the invention;

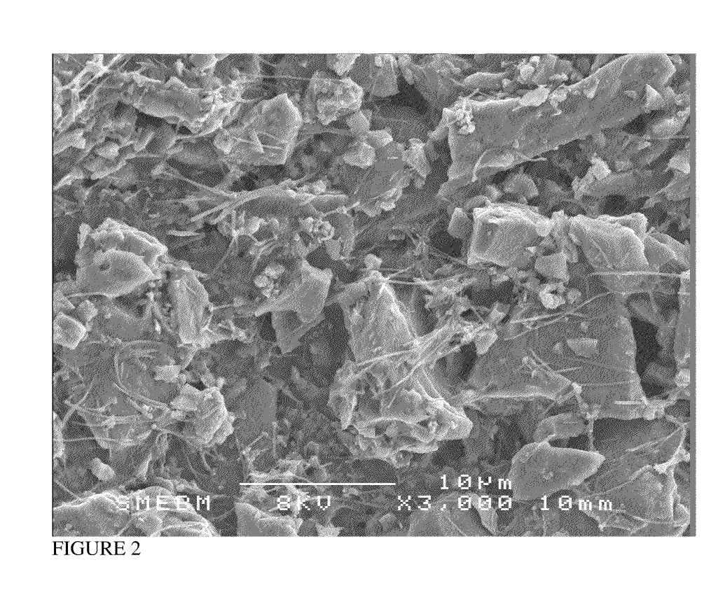

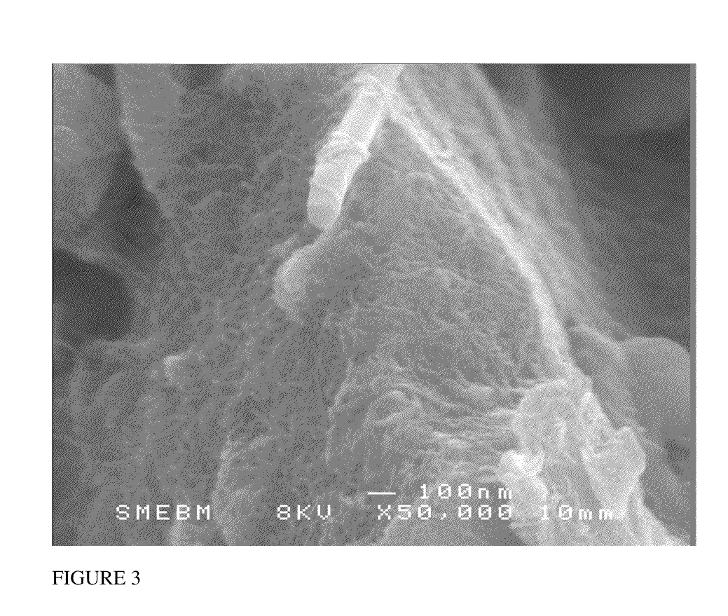

FIGS. 2 and 3 show scanning electron micrographs of the composite according to the invention at 3000 and 50 000 magnification respectively;

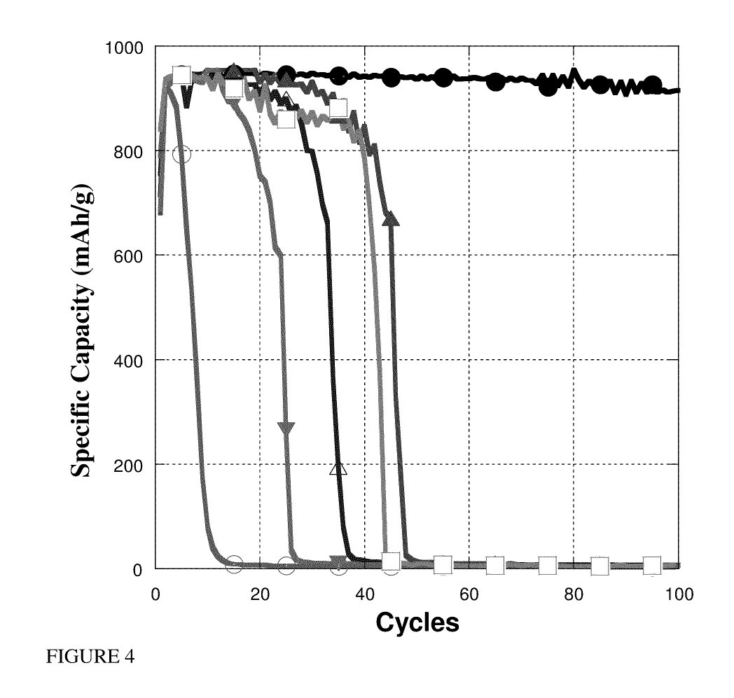

FIG. 4 shows curves of the variation in capacity Q as a function of the number of cycles for several specimens, one of which is made of a composite according to the invention; and

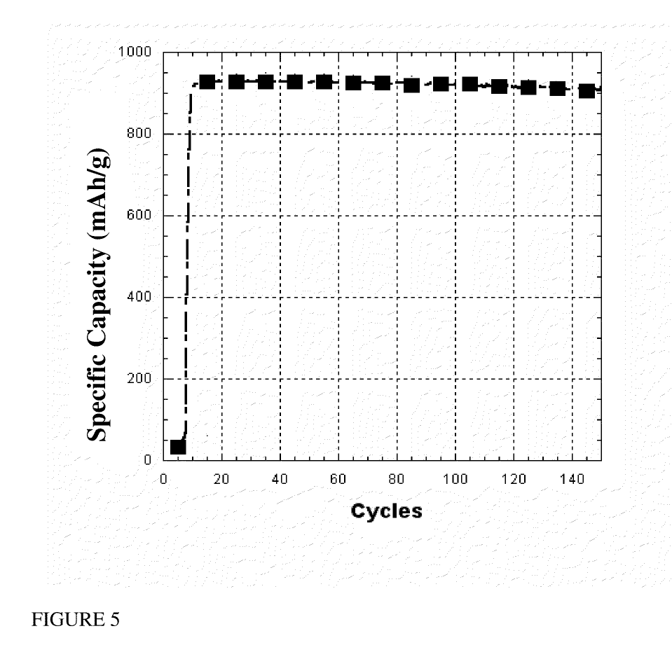

FIG. 5 shows the variation in the capacity Q for an electrode produced according to Example 2.

The proposed electrode composite according to the invention comprises a mixture of conductive additives containing at least carbon nanofibres (CNFs) and at least carbon nanotubes (CNTs).

The two conductive additives CNFs and CNTs differ from the conductive additives used in the prior art, such as sp-carbon or graphite, by their very high aspect ratio. This is defined as the ratio of the largest dimension to the smallest dimension of the particles. This ratio is around 30 to 1000 in the case of nanofibres and nanotubes, as opposed to 3 to 10 in the case of sp-carbon and graphite.

The Applicant noticed that, by choosing as conductive additive a mixture of conductive additives containing at least carbon nanofibres (CNFs) and at least carbon nanotubes (CNTs), both the carbon nanofibres and the carbon nanotubes in the electrode composite fulfil complementary roles with respect to capacity retention with cycling, which give a negative electrode based on an active element capable of reversibly forming alloys with lithium, having excellent cycling stability, even with high contents of active element in the electrode composite.

The carbon nanofibres, which are easily dispersed because of their large diameter, form a continuous structure capable of ensuring, from the current collector, electron transport throughout the volume of the composite. This structure may maintain its integrity despite the variations in volume of the particles of the active element because of the very great length of the carbon nanofibres, which are more difficult to disperse.

However, by virtue of the process according to the invention, it is possible to distribute them within the electrode composite in such a way that they form a network around the particles of the active element and thus play a role complementary to that of the nanofibres. On the one hand, they ensure that the electrons supplied from the current collector via the carbon nanofibres are distributed to the particles of the active element. On the other hand, because of their length and their flexibility, they form electrical bridges between the particles of the active element fractured by the repetitive volume expansions and contractions thereof.

Thus, the Applicant has found that the usual conductive additives (sp-carbon and graphite), with their relatively low aspect ratio, are markedly less effective than carbon nanofibres for maintaining electron transport from the current collector during cycling. This is because, with such conductive additives, the electrical pathways are formed by the juxtaposition of grains, and the contacts between them are easily broken as a result of the volume expansion of the particles of the active element.

Likewise, the usual conductive additives (sp-carbon and graphite), with their relatively low aspect ratio, are markedly less effective than carbon nanotubes for maintaining, during cycling, the distribution of the electrons to the fractured particles of the active element.

The mixture of conductive additives may furthermore include one or more other conductive additives formed by graphite, carbon black, such as acetylene black, and sp-carbon.

For applications such as the manufacture of electrodes for non-aqueous electrolyte secondary batteries and (Li-ion) secondary batteries, the electrode composite includes an element which is active with respect to lithium. This element is chosen from metals M and metal alloys MₐM_{b}M_{c} . . . that form with lithium an alloy of the LiₓMₐM_{b}M_{c} type.

Preferably, these metals M or metal alloys are chosen from Sn, Sb and Si.

The composite also comprises at least one polymer binder.

The polymer binder is chosen from polysaccharides, modified polysaccharides, latices, polyelectrolytes, polyethers, polyesters, polyacrylic polymers, polycarbonates, polyimines, polyamides, polyacrylamides, polyurethanes, polyepoxides, polyphosphazenes, polysulphones and halogenated polymers.

The composite has a submicron and micron-scale structure, which can be seen on a specimen using scanning electron microscopy (SEM).

The carbon nanofibres and carbon nanotubes have a fibrillar morphology. The carbon nanofibres differ from the carbon nanotubes by their larger diameter, 100 nm to 200 nm on average for the former as opposed to 10 to 20 nm on average for the latter. The length of the carbon nanofibres is generally around 10-30 μm and the length of the carbon nanotubes is generally around 5-15 μm.

The process according to the invention for preparing an electrode composition comprises:

preparation of a suspension containing a polymer P1, at least carbon nanofibres CNFs imparting electron conductivity, at least carbon nanotubes CNTs imparting electron conductivity, optionally a third conductive additive C1, an active electrode element M1 capable of reversibly forming an alloy with lithium, and a volatile solvent S1; and

production of a film from the suspension obtained.

Optionally, this film may be densified by applying pressure (between 0.1 and 10 tonnes).

During preparation of the suspension, the polymer P1 is introduced in the pure state or in the form of a solution into a volatile solvent; the CNF/CNT mixture is introduced in the pure state or in the form of a suspension into a volatile solvent.

The polymer P1 may be chosen from polysaccharides, modified polysaccharides, latices, polyelectrolytes, polyethers, polyesters, polyacrylic polymers, polycarbonates, polyimines, polyamides, polyacrylamides, polyurethanes, polyepoxides, polyphosphazenes, polysulphones and halogenated polymers. As examples of halogenated polymers, the following may be mentioned: homopolymers and copolymers of vinyl chloride, vinylidene fluoride, vinylidene chloride, ethylene tetrafluoride and chlorotrifluoroethylene; and vinylidene fluoride-hexafluoropropylene copolymers (PVdF-HFP). Water-soluble polymers P1 are particularly preferred. As examples, the following may be mentioned: carboxymethyl and hydroxypropylmethyl cellulose; polyethers, such as ethylene oxide homopolymers and copolymers; polyacrylic polymers, such as acrylamide and acrylic acid homopolymers and copolymers; maleic acid homopolymers and copolymers; maleic anhydride homopolymers and copolymers; acrylonitrile homopolymers and copolymers; vinyl acetate-vinyl alcohol homopolymers and copolymers; vinylpyrrolidone homopolymers and copolymers; polyelectrolytes, such as salts of vinylsulphonic acid and phenylsulphonic acid homopolymers and copolymers; and allylamine, diallyldimethylammonium, vinylpyridine, aniline and ethylenimine homopolymers and copolymers. Aqueous dispersions of polymers, called latices, may also be mentioned, these being based on vinyl acetate, acrylic, nitrile rubber, polychloroprene, polyurethane, styrene-acrylic or styrene-butadiene polymers. The term “copolymer” is understood in the present text to mean a polymer compound obtained from at least two different monomers. Polymer blends are also advantageous. Blends of carboxymethyl cellulose with styrene-butadiene, acrylic or nitrile-rubber latices may be mentioned.

The volatile solvent S1 is an organic solvent or water or an organic solvent/water mixture. N-methylpyrrolidone and dimethylsulphoxide may be mentioned as organic solvents.

The solvent S1 is preferably water. Its pH may be adjusted by the addition of an acid or base.

The solvent S1 may contain a surfactant. 4-(1,1,3,3-Tetramethylbutyl)phenyl polyethylene glycol (sold under the trade mark Triton® X100) may be mentioned.

As already stated, in addition to carbon nanofibres and carbon nanotubes, other conductive additives C1 may be added. The compound C1 may be formed by graphite, carbon black, such as acetylene black, or sp-carbon. A number of commercially available conductive additives meet this condition. In particular, the compounds Ensagri Super S® or Super P® sold by the company Chemetals may be mentioned.

The active element M1 may be chosen in particular from compounds that react with lithium during recharging of the Li-ion battery, for example:

metals M or metal alloys MₐM_{b}M_{c} . . . forming with lithium an alloy of the LiₓMₐM_{b}M_{c} type. These metals M or metal alloys are preferably chosen from M=Sn, Sb, Si, etc. and may be obtained from SnO, SnO₂, Sn and Sn—Fe(—C) compounds, Si, Si—C, Si—C—Al, Si—TiN, Si—TiB₂, Si—TiC, Si—TiO₂/ZrO₂, Si₃N₄, Si₃₋ₓFeₓN₄, SiO_{1.1}, Si—Ni, Si—Fe, Si—Ba—Fe, Mg₂Si(—C), Si—Ag(—C), Si—Sn—Ni, Si—Cu—C, Si—Sn compounds and Sb compounds); or

Cu₆Sn₅ compounds, iron borates, pnictides (for example Li_{3-y}CO_{y}N, Li_{3-y}Fe_{y}N, LiₓMnP₄, FeP, FeP₂, FeP₄, FeSb₂, Cu₃P, Zn₃P₂, NiP₂, NiP₃, CoP₃, CoSb₃, etc.), reversibly decomposing simple oxides (for example CoO, CO₂O₃, Fe₂O₃, etc.) and insertion oxides such as titanates (for example TiO₂, Li₄Ti₅O₁₂), and MoO₃ or WO₃.

The preparation of the suspension may be carried out in a single step or in two successive steps. When it is carried out in two successive steps, a first method of implementation consists in preparing a dispersion containing the carbon nanotubes and possibly all or some of the polymer P1 and then in adding, to this dispersion, the other constituents of the composite, this new suspension being used to produce the final film. A second method of implementation consists in preparing a dispersion containing the carbon nanotubes and possibly all or some of the polymer P1 in a solvent, in adding the active element M1, in removing the solvent, in order to obtain a powder, and then in forming a new suspension by adding the solvent S1 and the remainder of the constituents of the composite to this powder, this new suspension being used to produce the final film.

The preparation of a carbon nanotube dispersion is advantageous because it allows the formation of a more homogeneous composite film.

The film may be obtained from the suspension by any conventional means, for example by extrusion, by tape casting or by spray drying, on a substrate followed by drying. In the latter case, it is advantageous to use, as substrate, a metal foil capable of serving as collector for the electrode, for example a copper or nickel foil or mesh treated with a corrosion-protection coating. The film thus obtained on the substrate may be used directly as electrode.

The composite according to the invention is useful for producing electrodes for electrochemical devices, especially in lithium batteries. Another subject of the invention is a composite electrode formed by the material according to the invention.

A lithium battery comprises a negative electrode, formed from metallic lithium, a lithium alloy or a lithium insertion compound, and a positive electrode, the two electrodes being separated by a solution of a salt, the cation of which contains at least a lithium ion, such as for example LiPF₆, LiAsF₆, LiClO₄, LiBF₄, LiC₄BO₈, Li(C₂F₅SO₂)₂N, Li[(C₂F₅)₃PF₃], LiCF₃SO₃, LiCH₃SO₃, and LiN(SO₂CF₃)₂, LiN(FSO₂)₂, etc. in an aprotic solvent (ethylene carbonate, propylene carbonate, dimethyl carbonate, diethyl carbonate, methyl carbonate, etc.), all this serving as electrolyte. The negative electrode may be a composite electrode according to the invention, containing a negative electrode active element as defined above. When the positive electrode is formed by a lithium insertion compound, it may also be formed by a material according to the invention in which the active element is a positive electrode active element as defined above.

The present invention is illustrated by the following examples, to which however it is not limited.

### EXAMPLE 1

The composite of this example consisted of 80% by weight of 1-10 μm, 99.999% pure silicon particles (from Alfa Aesar), 8% by weight of CMC binder (carboxymethyl cellulose: DS=0.7, M_{w}=90 000, from Aldrich), and 4% by weight of raw carbon nanofibres and 8% by weight of raw carbon nanotubes manufactured for example by Arkema.

The nanotubes had a mean diameter of 20 nm and a length estimated to be a few microns, and their chemical composition showed that they contained about 7% mineral ash coming from the synthesis process.

The carbon nanofibres had a mean diameter of 150 nm and a length estimated to be 15 μm. They were supplied by Showa Denko.

All the carbon nanotubes for the composition of the composite together with a small amount of CMC corresponding to 1% by weight of the electrode were firstly dispersed in deionized water using a ball mill (Fritsch Pulveristette 7). The CMC was used here to incorporate and disperse the carbon nanotubes in the water. CMC is a polyelectrolyte which, because of the cellulose units present, can establish van der Waals bonds with the carbon nanotubes and be adsorbed on their surface, thus making them easier to be wetted by water, and, because of the presence of ionizable carboxylate groups, ensures that the nanotubes are well dispersed via an electrostatic repulsion mechanism. The dispersing conditions were 15 h at 700 revolutions/minute, a 12.5 ml milling jar containing three 10 mm-diameter balls, 1 ml of deionized water, 32 mg of nanotubes and 4 mg of CMC.

FIG. 1 gives the rheological characteristics of the dispersion after milling for 15 h. For a 32 mg dry extract of nanotubes and 4 mg of CMC in 1 ml of water, optimum electrochemical performance is obtained when the storage modulus G′ reaches a value of 800 Pa in the 0.1 to 10 Hz frequency range.

After the dispersion step, the silicon particles (320 mg), the carbon nanofibres (16 mg) and the remainder of the CMC (28 mg) were added, all this being mixed by comilling for 30 minutes at 500 revolutions per minute. The composite consisted of 28.57% by weight of the suspension, the remainder being deionized water.

The electrode was prepared by coating the suspension containing the composite on a 25 μm thick copper current collector. The height of the coating blade was set at 100 μm. The electrode was firstly dried at room temperature and then for 3 h at 55° C. under vacuum. For this example, the amount of silicon deposited per cm² of current collector was 1.70 mg and the thickness of the electrode was 15 μm.

FIGS. 2 and 3 show scanning electron microscopy (SEM) micrographs of the composite obtained, at 3000 and 50 000 magnification respectively. These show that the composite according to the invention consists of silicon particles, carbon nanotubes and carbon nanofibres. The latter differ from the former by their larger diameter—150 nm on average compared with 20 nm on average—and their greater length. The CMC is present in the form of a very thin layer on the surface of all the other materials. The carbon nanofibres form a continuous structure capable of ensuring electron transport from the current collector into the entire volume of the composite. The carbon nanotubes form a network around the silicon particles. It appears that the process according to the invention enables the two conductive additives to be very homogeneously distributed.

The electrode (a) thus obtained was mounted in a battery having as positive electrode a lithium metal foil laminated on to a nickel current collector, a glass fibre separator and a liquid electrolyte consisting of a 1M LiPF₆ solution dissolved in EC/DMC (1:1). The cycling performance was measured and compared with that of similar batteries in which the negative electrode was an electrode having the following initial composition:
(b) 80% Si, 8% CMC, 12% sp-carbon;
(c) 80% Si, 8% CMC, 12% carbon nanotubes;
(d) 80% Si, 8% CMC, 12% carbon nanofibres;
(e) 80% Si, 8% CMC, 4% carbon nanofibres, 8% sp-carbon;
(f) 80% Si, 8% CMC, 8% carbon nanotubes, 4% sp-carbon.

The cycling was carried out at a constant specific capacity limited to 950 mAh/g in the potential range 0-1 V versus Li⁺/Li. The cycling was controlled in galvanostatic mode at a current I of 150 mA/g, corresponding to C/6 mode (each charge-discharge cycle lasting 6.33 hours). This cycling mode gave a constant capacity provided that the potential at the end of reaction was greater than 0 V, then a capacity that decreased with the number of cycles when the potential at the end of reaction became equal to 0 V.

FIG. 4 shows the variation in the capacity Q (in mAh/g) as a function of the number of cycles N. The correspondence between the curves and the specimens is as follows:

Curve -—-: specimen a according to the invention;

Curve - [symbol] — [symbol] -: comparative specimen b;

Curve -◯—◯-: comparative specimen c;

Curve -□—□-: comparative specimen d;

Curve - [symbol] — [symbol] -: comparative specimen e; and

Curve -Δ—Δ-: comparative specimen f.

By comparing the cycling curves it may be seen that the cycling capacity is substantially improved only when the composite constituting the electrode contains the mixture of the two conductive additives claimed by the invention, namely carbon nanotubes and carbon nanofibres. The capacity retained at the one hundredth cycle is 900 mAh/g of silicon, i.e. 720 mAh/g of electrode. The capacity per unit volume of the electrode is about 630 mAh/cm³, which is to be compared with the capacity per unit volume of commercially available graphite anodes equal to about 500 mAh/cm³ (“Nano- and bulk-silicon-based insertion anodes for lithium-ion secondary cell”, U. Kasavajjula et al., J. Power Sources, 163 (2007) 1003-1039; “The effect of compression on natural graphite anode performance and matrix conductivity”, K. A. Striebel et al., J. Power Sources 134 (2004) 241-251; and “Benchmark study on high performing carbon anode materials”, C. Lampe-Onnerud et al., J. Power Sources, 97-98 (2001) 133-136). This performance is better than that reported in the prior art.

Since the final potential of 0 V thus never reached during cycling for 100 cycles, it should be noted that capacities in excess of 950 mAh/g may be obtained by modifying the cycling conditions. However any cycling at a capacity greater than 950 mAh/g is to the detriment of the cycling lifetime.

### EXAMPLE 2

Example 2 was obtained with an electrode according to the invention and a battery, these being prepared as in Example 1. For Example 2, the amount of silicon deposited per cm² of current collector was 1.80 mg.

The cycling was carried out at a constant specific capacity limited to 950 mAh/g within the potential range 0-1 V versus Li⁺/Li. The cycling was controlled in galvanostatic mode at a current I of 900 mA/g, corresponding to a C mode (each charge/discharge cycle lasting 1.05 hours).

FIG. 5 shows the variation in the capacity Q (in mAh/g) as a function of the number of cycles N. After an induction period of a few cycles, which can be attributed to the rate of impregnation of the electrode with the electrolyte, very good capacity retention is observed when cycling in C mode. The retained capacity after the one hundred and fiftieth cycle is 900 mAh/g of silicon, i.e. 720 mAh/g of electrode.

In practice, the CNT/CNF mixture preferably lies within the following limits:

Limit 1: 9% carbon nanofibres+3% carbon nanotubes;

Limit 2: 3% carbon nanofibres+9% carbon nanotubes.

Example 3 below is given to illustrate the results within these limits.

### EXAMPLE 3

The composite of this example consisted of 80% by weight of 1-10 μm, 99.999% pure silicon particles (from Alfa Aesar), 8% by weight of CMC binder (carboxymethyl cellulose, DS=0.7, M_{w}=90 000, from Aldrich) and 12% by weight of mixture of raw carbon nanofibres+raw carbon nanotubes.

All of the carbon nanotubes for the composition of the composite together with a small amount of CMC corresponding to 1% by weight of the electrode were firstly dispersed in deionized water using a ball mill (Fritsch Pulveristette 7). The dispersing conditions were 15 h at 700 revolutions/minute.

After the dispersing step, the silicon particles, the carbon nanofibres and the rest of the CMC were added, all this being mixed by comilling for 30 minutes at 500 revolutions per minute. The composite consisted of 28.57% by weight of the suspension, the rest being deionized water.

The electrodes were prepared by coating the suspension containing the composite on to a 25 μm thick copper current collector. The height of the coating blade was set at 100 μm. The electrodes were firstly dried at room temperature and then for 3 h at 55° C. under vacuum.

The electrodes thus obtained were mounted in a battery having as positive electrode a lithium metal foil laminated on to a nickel current collector, a glass fibre separator and a liquid electrolyte consisting of a 1M LiPF₆ solution dissolved in EC/DMC (1:1).

The cycling was carried out at a constant specific capacity limited to 950 mAh/g in the potential range 0-1 V versus Li⁺/Li. The cycling was controlled in galvanostatic mode at a current I of 150 mA/g, corresponding to C/6 mode (each charge-discharge cycle lasting 6.33 hours). This cycling mode gave a constant capacity provided that the potential at the end of reaction was greater than 0 V, then a capacity that decreased with the number of cycles when the potential at the end of reaction became equal to 0 V.

The table below gives the composition of the electrodes and their cycling lifetimes, the retained lifetime criterion being that the potential at the end of reaction becomes equal to 0 V:

| wt % | wt % | wt % CNFs | wt % CNTs | Lifetime |
|---|---|---|---|---|
| Si | CMC | (VGCF) | (MWNT) | (number of cycles) |
| 80 | 8 | 12 | 0 | 85 |
| 80 | 8 | 11 | 1 | 87 |
| 80 | 8 | 10 | 2 | 95 |
| 80 | 8 | 9 | 3 | 120 |
| 80 | 8 | 4 | 8 | 130 |
| 80 | 8 | 3 | 9 | 120 |
| 80 | 8 | 2 | 10 | 40 |
| 80 | 8 | 0 | 12 | 25 |

VGCF: Vapour growth carbon fibre;
MWNT: Multi-walled carbon nanotubes.

In the detailed description of the invention in the aforementioned document D2 [0038], it is stated that the fibrous carbon content is preferably greater than 3 but less than 12 parts per 100 parts of active material.

The amount provided in the present invention is greater than the upper limit of this interval, i.e. 12 parts of conductive additive per 80 parts (equivalent to parts per 100 parts) of active material. This is because, according to the present invention, the fibrous carbon content is greater than 12 parts per 100 parts of active material (i.e. 9.6% by weight in the electrode). For a lower content, the cycling stability is inferior, as illustrated in Example 4 below.

### EXAMPLE 4

The composite of this example consisted of 83% by weight of 1-10 μm, 99.999% pure silicon particles (from Alfa Aesar), 8% by weight of CMC binder (carboxymethyl cellulose, DS=0.7, M_{w}=90 000, from Aldrich) and 9% by weight of mixture of raw carbon nanofibres+raw carbon nanotubes.

All of the carbon nanotubes for the composition of the composite together with a small amount of CMC corresponding to 1% by weight of the electrode were firstly dispersed in deionized water using a ball mill (Fritsch Pulveristette 7). The dispersing conditions were 15 h at 700 revolutions/minute.

After the dispersing step, the silicon particles, the carbon nanofibres and the rest of the CMC were added, all this being mixed by comilling for 30 minutes at 500 revolutions per minute. The composite consisted of 28.57% by weight of the suspension, the rest being deionized water.

The electrodes were prepared by coating the suspension containing the composite on to a 25 μm thick copper current collector. The height of the coating blade was set at 100 μm. The electrodes were firstly dried at room temperature and then for 3 h at 55° C. under vacuum.

The electrodes thus obtained were mounted in a battery having as positive electrode a lithium metal foil laminated on to a nickel current collector, a glass fibre separator and a liquid electrolyte consisting of a 1M LiPF₆ solution dissolved in EC/DMC (1:1).

The cycling was carried out at a constant specific capacity limited to 950 mAh/g in the potential range 0-1 V versus Li⁺/Li. The cycling was controlled in galvanostatic mode at a current I of 150 mA/g, corresponding to C/6 mode (each charge-discharge cycle lasting 6.33 hours). This cycling mode gave a constant capacity provided that the potential at the end of reaction was greater than 0 V, then a capacity that decreased with the number of cycles when the potential at the end of reaction became equal to 0 V.

The table below gives the composition of the electrodes and their cycling lifetimes, the retained lifetime criterion being that the potential at the end of reaction becomes equal to 0 V:

| wt % | wt % | wt % | wt % | Lifetime |
|---|---|---|---|---|
| Si | CMC | VGCF | MWNT | (number of cycles) |
| 80 | 8 | 3 | 6 | 88 |

The lifetime expressed as the number of cycles becomes 88 instead of 120 if 12 parts per 80 parts of active material are chosen, as may be seen in the previous table.

1. Electrode composite comprising an active element exhibiting electrochemical activity, a conductive additive and a binder, wherein the conductive additive is a mixture of conductive additives comprising at least carbon nanofibres and at least carbon nanotubes, and wherein the carbon nanofibres have a diameter in a range from 50 to 200 nm and have an aspect ratio in a range from 10 to 1000 and wherein the carbon nanotubes have a diameter of between 0.4 and 20 nm and an aspect ratio of 20 to 1000.

2. Electrode composite according to claim 1, wherein the mixture comprises one or more other conductive additives chosen from graphite, carbon black, and sp-carbon.

3. (canceled)

4. Electrode composite according to claim 1, wherein the active element is chosen from elements operating on the principle of insertion (Li⁺), conversion, displacement and dissolution-recrystallization, for the electrode that contains said active element.

5. Electrode composite according to claim 4, wherein the active element is of the metal M or metal alloy MₐM_{b}M_{c} . . . type, capable of forming with lithium a reversible alloy of the LixMₐM_{b}M_{c} type.

6. Electrode composite according to claim 5, wherein the metal or metals are chosen from Sn, Sb and Si.

7. Electrode composite according to claim 1, wherein the binder is a polymer P1 chosen from polysaccharides, modified polysaccharides, latices, polyelectrolytes, polyethers, polyesters and polyacrylic polymers.

8. Electrode composite according to claims 1, wherein the content of carbon nanofibres and carbon nanotubes is greater than 12 parts per 100 parts of active material.

9. Electrode composite according to claim 8, wherein the electrode composite comprises on average 4% by weight of raw carbon nanofibres and on average 8% by weight of raw carbon nanotubes.

10. Electrode composite according to claim 9, wherein the electrode composite comprises 80% by weight of Si particles and 8% by weight of binder.

11. Electrode comprising a composite according to claim 1.

12. Electrode according to claim 11, wherein the electrode is a negative electrode adapted for electrochemical devices of the lithium battery type.

13. Electrode according to claim 11, wherein the electrode is a negative electrode adapted for non-aqueous electrolyte secondary batteries.

14. Secondary (Li-ion) battery comprising a negative electrode comprising the composite according to claim 1.

15. Secondary (Li-ion) battery according to claim 14, wherein, during its operation, the charge and discharge operations involve lithium insertion ranging from 0 to 1.1 lithium atoms inserted per silicon atom.

16. Process for manufacturing an electrode composite according to claim 1, the process comprising:
preparing a suspension containing a binder, at least carbon nanofibres imparting electron conductivity, at least carbon nanotubes imparting electron conductivity, an active electrode element capable of reversibly forming an alloy with lithium, and a volatile solvent; and
producing a film from the suspension obtained.

17. Process for manufacturing an electrode composite according to claim 16, the process comprising densifying the film by applying a pressure of between 0.1 and 10 tonnes.

18. Process for manufacturing an electrode composite according to claim 16, wherein the suspension comprises a third conductive additive.

19. Process for manufacturing a composite according to claim 16, wherein the active electrode element is chosen from compounds that react with lithium during the recharging of the Li-ion battery.

20. Process for manufacturing a composite according to claim 16, the process comprising, during preparation of the suspension, introducing the binder, which is formed by a polymer, in the pure state or in the form of a solution into the volatile solvent and introducing the carbon nanofibres/carbon nanotubes mixture in the pure state or in the form of a suspension into a volatile solvent.

21. Process for manufacturing a composite according to claim 20, wherein the polymer may be chosen from polysaccharides, modified polysaccharides, latices, polyelectrolytes, polyethers, polyesters and polyacrylic polymers.

22. Process for manufacturing a composite according to claim 20, wherein the volatile solvent is an organic solvent or water or an organic solvent/water mixture.

23. Process for manufacturing a composite according to claim 22, wherein the organic solvent is chosen from N-methylpyrrolidone or dimethylsulphoxide.

24. Process for manufacturing a composite according to claim 16, wherein the preparation of the suspension is carried out in a single step or in two successive steps.

25. Process for manufacturing a composite according to claim 16, wherein the preparation of the suspension is carried out in two successive steps, the preparing process consisting of:
preparing a first dispersion containing the carbon nanotubes and, optionally, all or some of the polymer; and then
adding, to the first dispersion, the other constituents of the composite to form a second dispersion, the second dispersion being used to produce the film.

26. Process for manufacturing a composite according to claim 16, wherein the preparation of the suspension consists of:
preparing a first dispersion containing the carbon nanotubes and, optionally, all or some of the polymer in a solvent,
adding the active element,
removing the solvent, in order to obtain a powder, and then
forming a second dispersion by adding a solvent and the remainder of the constituents of the composite to the powder, the second dispersion enabling the film to be produced.

27. Process for manufacturing a composite according to claim 16, wherein the film is obtained from the suspension by extrusion, by tape casting or by spray drying on a substrate followed by drying.

28. Process for manufacturing a composite according to claim 27, wherein a metal foil capable of serving as collector for the electrode.

29. Process for the manufacture of electrodes for electrochemical devices of the lithium battery type, the process comprising manufacturing an electrode composite according to claim 16, and incorporating the electrode composite as an electrode.

30. Process for the manufacture of an electrode for electrochemical devices of the lithium battery type, the process comprising manufacturing a composite according to claim 27, and directly incorporating the film on the substrate as the electrode.

31. Process for manufacturing a non-aqueous electrolyte secondary battery having an electrode the process comprising manufacturing a composite according to claim 16, and incorporating the composite as the electrode.
